(19) United States
(12) Patent Application Publication
(10) Pub. No.: US 2007/0089126 A1
(43) Pub. Date: Apr. 19, 2007

(54) Apparatus and method for customizing a received signal

(75) Inventors: Thomas Michael Fritz, Farmingdale, NY (US); Frank Kobylinski, South Huntington, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Chyron Corporation, Melville, NY (US)

(21) Appl. No.: 11/253,167

(22) Filed: Oct. 18, 2005

(51) Int. Cl. H04N 7/10

(52) U.S. Cl. 725/32

(57) ABSTRACT

An apparatus and method for customizing a pre-existing signal that includes at least a video signal. The video signal is received at a video interface, and data used for customizing the video signal is received at a data interface. The data is applied to the video signal to generate a customized video signal.

### FIELD OF THE INVENTION

The present invention relates to communication systems, and more particularly, to an apparatus and method for customizing a pre-existing video signal or pre-existing audio-visual signal.

### BACKGROUND OF THE INVENTION

There are many occasions when it is beneficial to customize the exhibition of a pre-existing video signal or pre-existing audio-visual signal. Indeed, it is often beneficial to customize a received broadcast signal according to the circumstances at the location where the signal is received. For example, a local television network may want to add local weather information to a television signal it has received from a national network. For example, a local network may wish to add a “crawl” to the television signal, whereby textual information concerning the local weather is scrolled along the bottom of the displayed television picture. Or, the local network may want to temporarily interrupt the audio portion of the television broadcast with audio concerning the local weather. Of course, the insertion of local weather information is merely an example of one context in which signal customization is performed, and signal customization is not limited to the context of inserting local weather information.

While customization of pre-existing video signals and audio-visual signals is currently being performed, the cost of the equipment necessary to implement customization has effectively limited the use of customization systems to commercial broadcasters, who are most able to bear the cost of such systems. Further, the cost of prior customization systems is proportional to their capabilities and thus the systems offering the widest range of customization options are least likely to be within the cost constraints of individuals and small businesses.

### SUMMARY OF THE INVENTION

In view of the desirability of signal customization systems that offer a wide range of customization options in a cost-efficient manner, the present invention was conceived.

The invention provides an apparatus and method for customizing a pre-existing signal that includes at least a video signal. The video signal is received at a video interface and data used for customizing the video signal is received at a data interface. The data is applied to the video signal to generate a customized video signal.

### BRIEF DESCRIPTIONS OF THE DRAWINGS

The following detailed description, given by way of example, but not intended to limit the invention solely to the specific embodiments described, may best be understood in conjunction with the accompanying drawings wherein like reference numerals denote like elements and parts, in which:

FIG. 1 shows how a signal customization unit in accordance with a preferred embodiment of the invention customizes a received broadcast signal for display at a remote location.

FIGS. 2A-2D are examples of the display of customized video signals.

FIG. 3A is a front view of a signal customization unit according to a preferred embodiment of the invention.

FIG. 3B is a rear view of a signal customization unit according to the preferred embodiment shown in FIG. 3B.

FIG. 4 is a block diagram showing components of the unit depicted in FIGS. 3A and 3B.

FIG. 5 is a flow chart depicting the steps involved in a process of converting a user-created data page into data parsed for use by the unit of FIG. 4.

FIG. 6 shows the elements of the parsed data of FIG. 5 and shows how those elements are used by the unit of FIG. 4 to customize an audio-visual signal.

### DETAILED DESCRIPTION

For purposes of clarity of presentation, the following description is provided in the context of a signal that is received from a location that is remote from the location where the signal is customized. However, in other embodiments of the invention a signal may be customized at the location where it is generated. Also, the signal to be customized may be generated at the same location where it is received.

In light of the following description, one skilled in the art of the invention can readily implement the invention in the context of customizing a signal at the location where it is generated. Further, in light of the following description, one skilled in the art of the invention can readily implement the invention and in the context of customizing a signal that is generated at the same location where it is received.

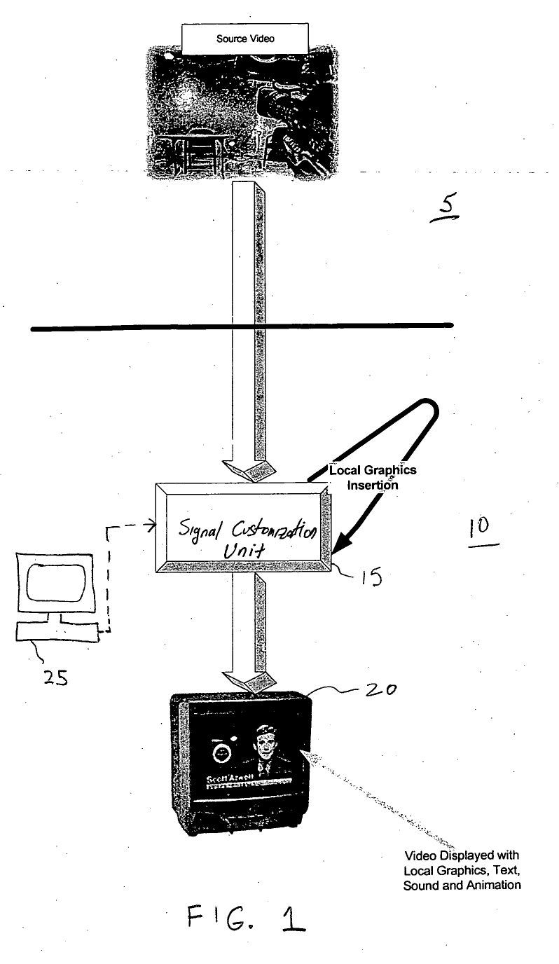

The present invention is directed to an apparatus and method for customizing a pre-existing signal. In a preferred embodiment of the invention, a received video signal (the “pre-existing video signal”) is customized at a reception sight that is remote from the source of the video signal. FIG. 1 depicts such a preferred embodiment. In FIG. 1, a video signal generated at a broadcast station 5 is received at a remote location 10. The signal is processed by a signal customization unit 15 prior to display on television set 20. A personal computer 25 may be coupled to the signal customization unit for purposes of passing data and or control information to the unit. In the preferred embodiment of FIG. 1, the signal customization unit is shown as inserting “graphics.” However, the unit may be used to insert graphics, text and/or video, and the inserted material may be provided at various levels of transparency. Thus, for example, material may be inserted at a 0% transparency, in which case the material is said to be “overlaid” on the received video signal, or the material may be inserted at 50% transparency, in which case the material is evenly “mixed” with the received video signal such that the received signal and the material appear as visible within each other.

It should be noted that the “mixing” of the material with the received video signal is not limited to 50% transparency. Indeed, the material may be mixed with the received video signal at any transparency between 0% and 100%.

Examples of remote locations that could make use of such a local signal customization unit include restaurants, airports and hospitals. For instance, a restaurant may use such a system to superimpose or display information about the day's specials on a received television broadcast so that customers sitting in a waiting area can watch a televised broadcast while reading about the specials. In an airport, flight status information could be superimposed or displayed on a television located in a passenger waiting area so that passengers can be informed of flight delays. In a hospital, information regarding the location of various wards could be superimposed or displayed on television sets located throughout the hospital.

It should be noted that the present invention is not limited to the remote locations of restaurants, airports and hospitals. Indeed, upon viewing this disclosure one skilled in the art of the invention will readily appreciate the wide range of remote locations suitable for use with the invention.

It should be further noted that the present invention is not limited to the customization of video signals only. For example, the invention may be used to customize both an audio signal and a video signal that are included in a received audio-visual signal, or just a video signal that is included in a received audio-visual signal. In one such application, the invention can be used to periodically replace an audio signal included in a received audio-visual signal with a brief audio message concerning some activity at the remote location. Upon viewing this disclosure one skilled in the art of the invention will readily appreciate the wide range of signal types that may be customized according to the invention.

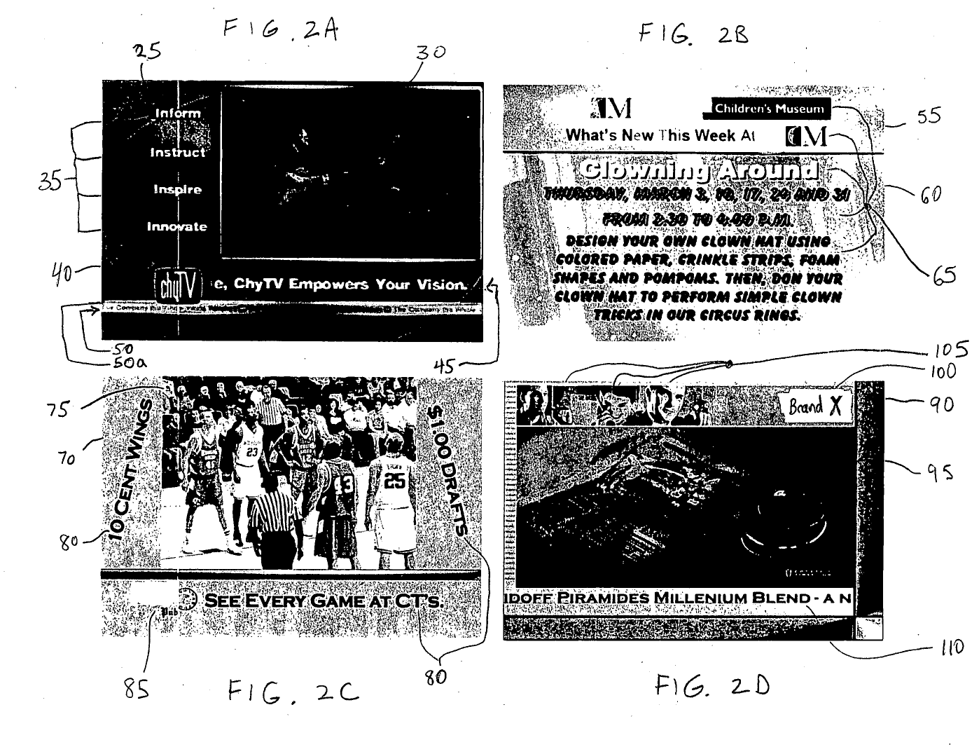

FIGS. 2A-2D, show several examples of displayed video signals that have been customized by the signal customization unit of FIG. 1.

FIG. 2A shows a customized video signal including a background 25, a squeezed video signal 30, fixed text 35, a graphic 40, a first crawl 45, and a second crawl 50. The customized signal of FIG. 2A has been generated for the purpose of advertising the ChyTV™ product on a screen used for the display of television signals. In order not to display promotional information directly on top of the received signal, the received signal is “squeezed” into an upper-right-hand portion of the display and the promotional information is displayed about the squeezed signal. Crawl 45 is made up of text that moves, or “crawls,” across the screen in a right-to-left direction (from a viewer's perspective). Crawl 50 also includes text that moves across the screen from right-to-left, but the text of crawl 50 appears on a background 50a that is different from background 25 so as to make the text of crawl 50 stands out.

FIG. 2B shows an implementation of the invention in which a locally generated video signal is displayed in lieu of a received video signal. In a preferred embodiment, the locally generated signal is periodically displayed in lieu of the received signal to create a customized video signal that is made up of the locally generated signal interspersed with the received signal. However, in an alternative embodiment, the locally generated signal is displayed in lieu of the received signal in a non-periodic fashion. Further, the locally generated signal may be is displayed in lieu of the received signal at all times, on only one occasion, or on more than one occasion. In any event, the locally generated signal in FIG. 2B includes an upper background 55, a lower background 60, and fixed text of various styles 65.

FIG. 2C shows a customized video signal including a background 70, a squeezed video signal 75, fixed text 80, and a logo 85. The squeezed video signal is displayed in an upper-middle portion of the display. The customized signal of FIG. 2C has been generated for use in a pub. The pub's “10 CENT WINGS” and “$1.00 DRAFTS” specials appear on the display along with the pub's logo and a notice that “EVERY GAME” is shown at the pub.

FIG. 2D shows another implementation of displaying a locally generated video signal in lieu of a received video signal. The locally generated signal in FIG. 2D includes a background 90, a video signal 95, a product logo 100, still pictures 105, and a crawl 110. In the FIG. 2D embodiment, all of the displayed information relates to an advertised product, “Brand X” cigars. As in the case of FIG. 2B, the locally generated signal may be periodically displayed in lieu of the received signal to create a customized video signal that is made up of the locally generated signal interspersed with the received signal. Or, the locally generated signal may be displayed in lieu of the received signal in a non-periodic fashion. Further, the locally generated signal may be displayed in lieu of the received signal at all times, on only one occasion, or on more than one occasion.

It should be noted that the use of crawling text in the invention is not limited to right-to-left crawling. A wide variety of text effects can be used with the invention. For example, text added by the signal customization unit of FIG. 1 can scroll across a display screen in a vertical fashion, can be faded-in and/or can be faded-out. Upon reviewing this disclosure, one skilled in the art of the invention will readily appreciate the wide range of effects that can be applied to text added to a received video signal in accordance with the invention.

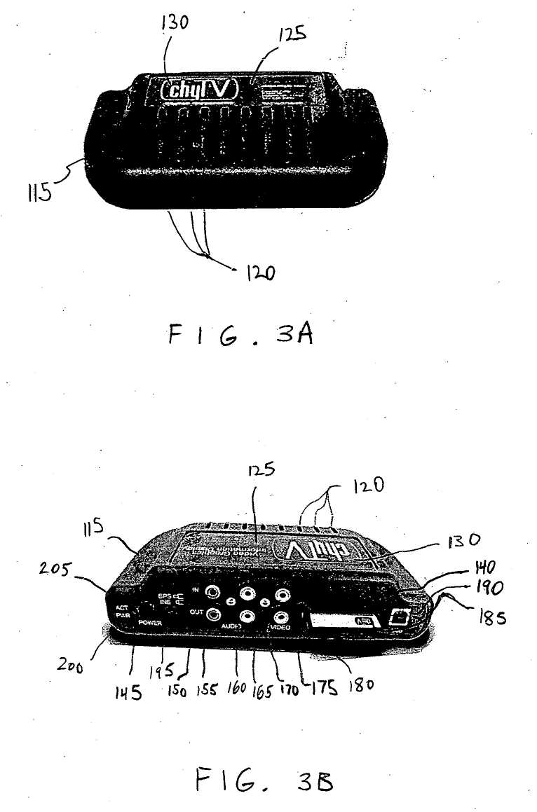

FIG. 3A is a front view of a signal customization unit according to a preferred embodiment of the invention. The unit includes a housing 115 having a multiple of openings 120. The openings are formed in a stylized fashion and function as a vent for the circuitry located within the housing. The housing includes a flattened top portion 125 for displaying a logo of, for example, the unit's manufacturer. The unit has a height of about 1.75 inches, a width of about 7.5 inches, and a depth of about 11.5 inches. It weighs approximately one pound.

FIG. 3B is a rear view of a signal customization unit according to the preferred embodiment shown in FIG. 3B. As can be seen from the figure, the unit includes a back panel 140 having a multiple of connectors, a push-button, and two indicator lights. More specifically, the back panel of the unit includes a power connector 145 for coupling the unit to a power source, a multiple of RCA-type connectors 150-175 for inputting and outputting audio and video signals, and connector 180 for coupling a removable solid-state memory 185 to the unit, a universal serial bus (USB) connector 190 for coupling a computer to the unit, a push-button 195 for selectively bypassing the signal customization function of the unit, a “powered” indicator LED 200, and an “active” indicator LED 205.

Regarding the power connector, the connector is preferably suitable for receiving a direct current (DC) power signal. The preferable power supply for the system is a 5V DC signal.

Regarding the RCA-type connectors, connectors 150 and 160 provide an interface for respective right and left channels of an input stereo audio signal. Connectors 155 and 165 provide an interface for respective right and left channels of an output stereo audio signal. Connector 170 provides an interface for an input composite video signal, and connector 175 provides an interface for an output composite video signal.

Connector 180 provides the interface for the removable solid-state memory. One type of removable solid-state memory that may be used is the CompactFlash™ Memory from Sandisk, although many alternative memories may be employed without departing from the spirit of the invention. Moreover, it should be noted that the invention is not limited to a removable solid-state memory. For example, a removable or non-removable magnetic disk drive, optical disk drive, and/or tape cassette may be used instead of a removable solid-state memory or in conjunction with a removable solid-state memory.

In any event, the removable solid-state memory stores information used in customizing audio and/or video signals input through connectors 150, 160 and 170. FIG. 3B shows a removable solid state memory 185 inserted into connector 180. However, it is noted that the memory is not an integral part of the customization unit.

The USB connector is used to couple the device to a computer such as personal computer (PC) 25 of FIG. 1. The USB port receives information generated at the PC and used for customizing audio and/or video signals input through connectors 150, 160 and 170. Customization information received through the USB port from the PC can be used as an alternative to customization information received through connector 180 from memory 185, or can be used in conjunction with customization information received through connector 180. In any case, the customization information may include customization data and/or customization control information.

It should be noted that the invention is not limited to using a USB connection to couple the signal customization unit to a computer. For example, an Ethernet connection can be used to couple the signal customization unit to a computer. In one possible Ethernet embodiment of the signal customization unit, an Ethernet connector is used instead of USB connector 190. Further, the invention is not limited to coupling the signal customization unit to only one computer. The unit can be coupled to more than one computer. Still further, the invention is not limited to coupling the signal customization unit to one or more computers directly. The unit may be coupled to one or more computers indirectly through a computer network.

The push-button is used to bypass video and audio signal customization. That is, when the push-button is in the “in” (or “insert”) position, the customization unit modifies an audio-visual signal input through connectors 150, 160 and 170 in accordance with customization information received through connector 180 and/or USB connector 190 and outputs the customized signal; and when the push-button is in the “out” (or “bypass”)position, the customization unit bypasses all customization operations and merely supplies the input audio-visual signal as the output audio-visual signal.

The LEDs 200 and 205 light up to respectively indicate when the unit is powered and when a memory inserted in memory port 280 is being accessed.

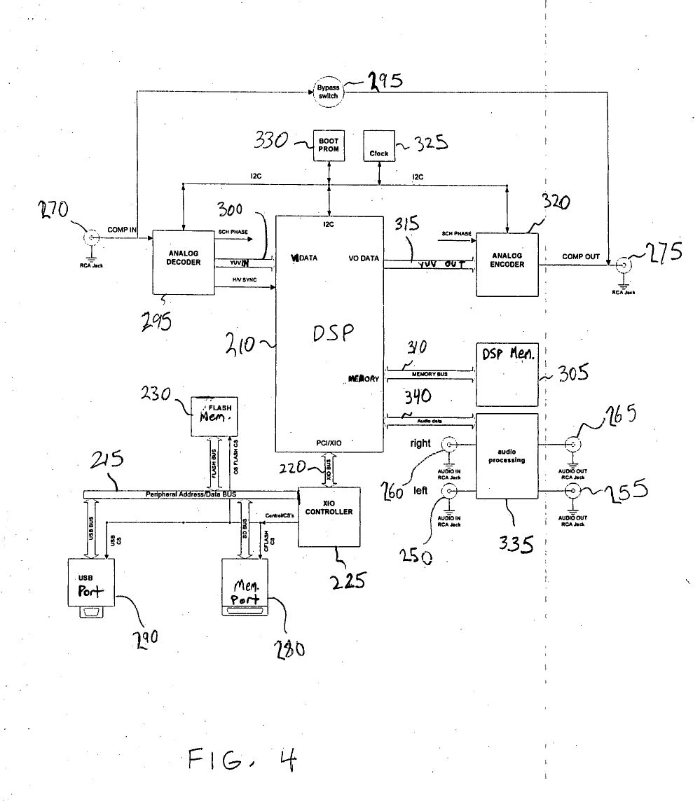

Referring now to FIG. 4, the unit of FIGS. 3A and 3B will be discussed in further detail. FIG. 4 is a block diagram showing components of the unit depicted in FIGS. 3A and 3B. As can be seen from FIG. 4, the unit includes a digital signal processor (DSP) 210 for performing customization of an audio signal and/or video signal. The DSP is coupled to a DSP memory 305 via a memory bus 310. Notably, the DSP does not require an operating system and is capable of stand-alone operation once it is programmed. Preferably, the DSP is made up of a multiple of co-processing units, including an image co-processor. Although, a DSP that is not made up of a multiple co-processing units may also be used. One example of a processor suitable for use with the invention is the TriMedia PNX1302, although the invention may be implemented with a DSP other than the TriMedia PNX1302.

The DSP is coupled to a peripheral address/data bus 215 via an external input output (XIO) bus 220 and an XIO controller 225. Also coupled to the peripheral bus are a USB port 290 (associated with connector 190), a memory port 280 (associated with connector 180) and a flash memory 230, each being coupled to the peripheral bus by a respective device bus. The memory port and USB port serve as data input interfaces. Through the peripheral bus and device buses, signal customization information is read-in through the USB port or memory port and stored in the flash memory. The process of reading-in information from the ports and storing it in the flash memory 230 is controlled by the XIO controller. When the information is to be used by the DSP, the XIO controller reads the information into the DSP via the flash memory device bus, the peripheral bus, XIO controller, and XIO bus. The customization information may include customization data and customization control information.

The DSP is also coupled to an analog decoder 295. The analog decoder serves as a video input interface. The decoder receives composite video from a composite video input port 270 (associated with RCA-type connector 170), and converts the composite video into digital YUV component video 300. The digital component video is passed to the DSP for customization. The analog decoder also passes signaling channel phase and horizontal/vertical synchronization information to the DSP. The signaling channel phase provides an indication of the relative phase between the color components of the digital component video. The signaling channel phase and horizontal/vertical synchronization information may be used for genlocking the digital component video.

A customized video signal 315 results from customizing the video signal input at port 270 according to customization information stored in flash memory 230. The customized video signal is output from the DSP in the form of digital YUV component video. The DSP also outputs signaling channel phase information for the customized video signal. Both the signaling channel phase information and the digital YUV component video are received at an analog encoder 320. The analog encoder serves as a video output interface. The encoder converts the digital YUV component video to composite video to form a customized video signal in composite video format. The customized composite video signal is passed to a video output port 275 (associated with RCA-type connector 175).

In order for the DSP to perform in synchronization with the analog decoder and analog encoder, a common clock 325 is provided to the three elements. Further the DSP, decoder and encoder are booted from a common boot prom 330.

In the event that a user wishes to bypass customization of a video signal received at port 270 and simply pass the received signal to output port 275, a bypass switch 295 (associated with push-in button 195) couples port 270 to port 275.

Regarding the processing of audio signals, a stereo audio signal may be input at audio ports 250 and 260 (associated with RCA-type connectors 150 and 160, respectively). Port 250 corresponds to the right channel stereo signal and port 260 corresponds to the left channel stereo signal. The ports couple the input audio signal to an audio processing portion 335. The audio processing portion includes an audio decoder and an audio encoder. The audio decoder serves as an audio input interface. The decoder performs an analog-to-digital (A/D) conversion of incoming audio signals received at ports 250 and 260. The audio encoder serves as an audio output interface. The encoder performs a digital-to-analog (D/A) conversion on output audio signals prior to passing the output signals to output ports 255 and 265 (associated with RCA-type connectors 155 and 165, respectively). Port 265 outputs right channel customized audio, and port 255 outputs left channel customized audio.

When an input audio signal is to be customized, it is A/D converted by the audio decoder and passed to the DSP for processing via an audio data bus 340. In a preferred embodiment, the DSP customizes input audio signals according to audio customization information received at the DSP via flash memory 230. The audio customization information is received at the flash memory via the USB port and/or memory port, and it may include audio customization data and/or audio customization control information.

The audio customization data can be in the form of one or more waveform (WAV) files. The WAV file(s) may be substituted for an input audio signal or mixed with an input audio signal according to the audio customization control information. By way of example, the audio customization control information may specify that a WAV file included in the audio customization data be substituted for an input audio signal in the following ways: (1) such that the WAV file audio plays in a continuous loop in lieu of the audio of the input audio signal, (2) such that the WAV file audio is periodically played in lieu of the audio of the input audio signal (to create a customized audio signal that is made up of the WAV file audio interspersed with the audio of the input audio signal), (3) such that the WAV file audio is substituted for the audio of the input audio signal in a non-periodic fashion, (4) such that the WAV file audio is substituted for the audio of the input audio signal on only one occasion, or (5) such that the WAV file audio is substituted for the audio of the input audio signal on more than one occasion.

In any case, substitution or mixing of a WAV file with an input audio signal is performed at by the DSP in the digital domain to create a digital customized audio signal. The digital customized audio signal is then passed back to the audio processing portion 335 via audio data bus 340 where it is D/A converted by the audio encoder to generate an analog customized audio signal. The analog customized audio signal is output from the signal customization unit via ports 255 and 265.

It should be noted that customization of input audio signals is optional. That is, audio signals input at ports 250 and 260 may be passed to ports 255 and 265 without modification.

Preferably, all of the elements of FIG. 4 are located on a single printed circuit board.

Having described a preferred embodiment of the signal customization unit, the process of customizing signals in accordance with the invention will be further described.

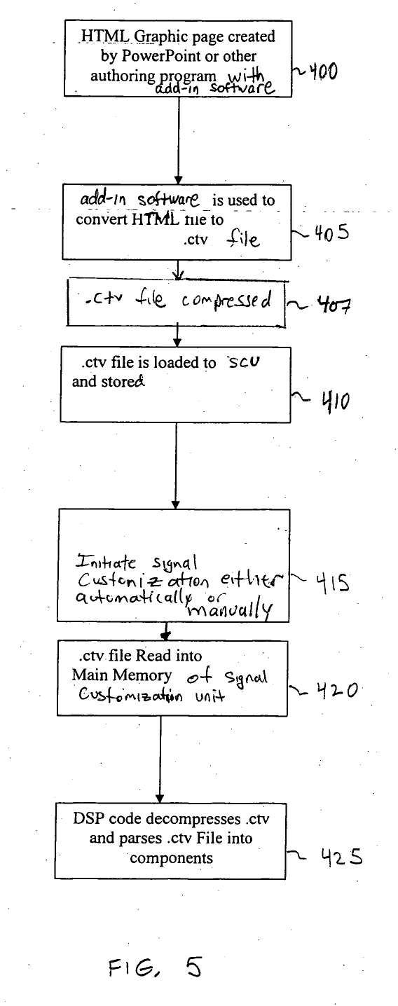

FIG. 5 is a flow chart depicting the steps involved in a process of converting a user-created data page into data parsed for use by the unit of FIG. 5. In the embodiment of FIG. 5, a user designs the layout of the customized video signal using a PC running a pre-existing authoring program with add-in software that adapts the program to facilitate the program's use for video signal customization applications. For example, a user uses a PC running the Microsoft PowerPoint™ authoring program with add-in software to create a hypertext mark-up language (HTML) graphic page that depicts a customized video signal such as that shown in FIG. 2A (step 400). As an option, a new program can be used to design the layout of the customized video signal.

In the preferred case of creating the layout in an HTML format, the add-in software converts the HTML file to a format used in the signal customization unit (step 405). For purposes of this description the format used in the signal customization unit will be referred to as the “.ctv” format, and a file containing customization information in the .ctv format will be referred to as a “.ctv.” file.

Next, the .ctv file is compressed (step 407), passed to the signal customization unit, and stored in the unit (step 410). For example, the .ctv file is passed to the signal customization unit of FIG. 4 and stored in flash memory 230.

Once the .ctv file is stored in the signal customization unit, signal customization according to the file can be triggered either automatically from a play list stored in the unit, or manually by user command (step 415). In an example of the play list embodiment, each .ctv file is given a title and the signal customization unit is provided with a play list (or “schedule”) which cross-references .ctv files with times-of-play. A particular file is “played” when a comparison of the unit's internal clock and the file's time-of-play indicates that the file should be played. In an example of playing a file in response to a manual command, a PC such as PC 25 in FIG. 1, is used to send a command to the unit indicating that a specified .ctv file be played.

In response to the initiation of signal customization, the .ctv file to be played is read into the main memory of the signal customization unit (step 420). For example, the .ctv file to be played is read into DSP memory 305 of FIG. 4. Once the .ctv file has been read into the main memory of the unit, the unit's DSP decompresses the file and parses it into its components (step 425).

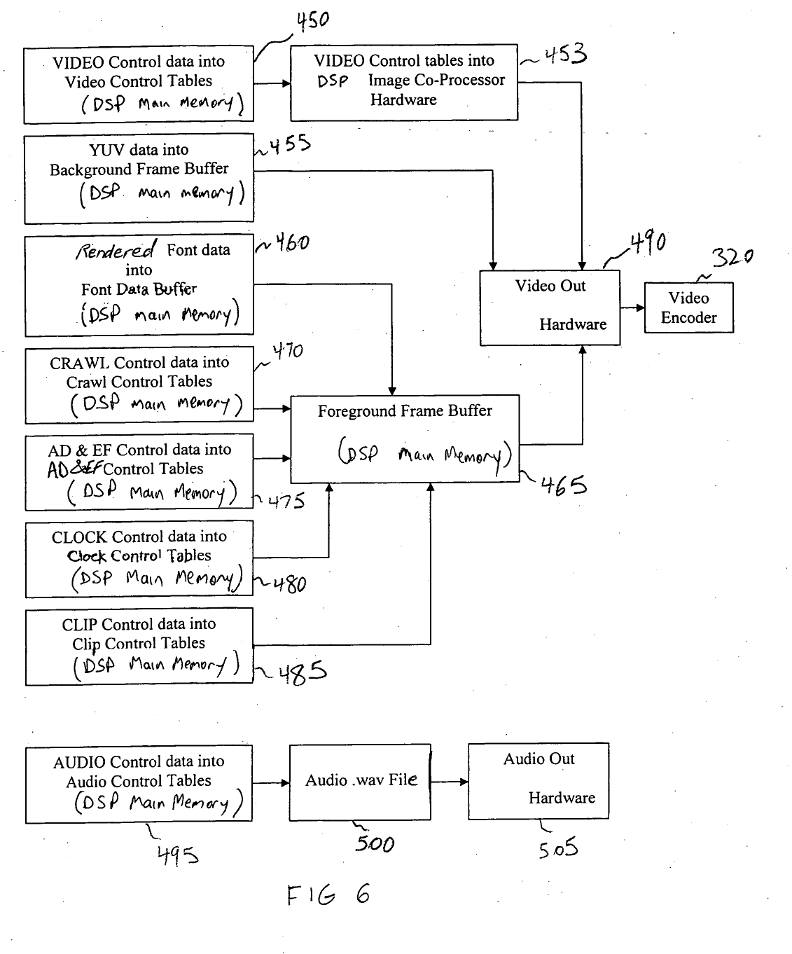

FIG. 6 shows the elements of a .ctv file according to a preferred embodiment of the invention and shows how those elements are used by the unit of FIG. 4 to customize an audio-visual signal. As can be seen from FIG. 6, the preferred elements of the .ctv file are video control data, YUV data, rendered font data, crawl control data, active data (AD) and effects data (EF) control data, clock control data, clip control data, and audio control data. Thus, the file includes (1) video customization data in the form of YUV data and rendered font data; (2) video customization control information in the form of video control data, crawl control data, AD and EF control data, clock control data and clip control data; and (3) audio customization control information in the form of audio control data. Input of audio customization data in the form of one or more WAV files is handled apart from the .ctv file.

As can be seen from FIG. 6, each of the elements of the parsed .ctv file is transferred to a corresponding area of the DSP main memory 305.

The video control data is stored in video control tables within the main memory (step 450). The video control tables are passed to an image co-processor of the DSP where they are used to control the display of the video portion of the signal that is being customized (step 453). For example, the video control tables (generated based on the video control data) are used to squeeze a received video signal into an upper-right-hand portion of a display screen (see e.g. element 30 of FIG. 2A). The video control data in combination with the DSP allows for smooth dynamic movement and/or resizing of the received video signal.

The YUV data is stored in a background frame buffer of the main memory (step 455). The YUV data is used, along with any other data that may be stored in the background buffer, to form the background of the customized video signal. For example, the background data is used to form a background such as background 25 of FIG. 2A.

The rendered font data is stored in a font data buffer of the main memory (step 460). The rendered font data includes information concerning the size and shape of characters used to represent text that is to be generated for purposes of customizing a received video signal. Thus, when adding text of a particular font to a received signal, the signal customization unit does not need to derive the necessary characters from a “true-type font,” but rather, merely generates the characters based on the size and shape data already stored in the font data buffer. Moreover, the rendered font data stored in the main memory includes data for one or more complete character sets such that once rendered data for a font has been stored in the main memory, the signal customization unit can display various combinations of characters in that font without having to render the characters based on a true-type font. Thus, if a first text message is displayed using rendered font data stored in the rendered font buffer, and a user wants to change the first text message to a second text message different from the first but to be displayed in the same font, the new display text is generated by recalling the rendered font data already present in the font data buffer. No processing of true-type font data is necessary for any characters of the new text that are different from characters in the old text.

By providing rendered font data to the signal customization unit, the unit is relieved of the burden of having to render fonts for display. Rendered font data corresponding to messages that are to be displayed is passed to a foreground frame buffer within the main memory (reference 465).

The crawl control data is stored in crawl control tables within the main memory (step 470). The crawl control tables are used to generate crawls such as crawls 45 and 50 of FIG. 2A. The crawls are stored in the foreground frame buffer in preparation for display (reference 465).

The AD and EF control data is stored in AD and EF control tables within the main memory (step 475). A segment of AD data specifies text, an area within a display screen, and one or more text effects. In response to the AD segment, the signal customization unit causes the specified text to be displayed in the specified area according to the specified effects. A segment of EF control data specifies effects that may be applied to text specified apart from the EF segment. Thus, a text message displayed according to the area and effects of an AD segment can be changed by merely providing the signal customization unit with new text, the new text then being displayed in the same area and with the same effects as the old text. Whereas, a text message displayed according to an EF segment can only be changed by changing the portion of data in which the original EF text was specified. Text generated according to AD and EF control data is passed to the foreground frame buffer in preparation for display (reference 465).

The clock control data is stored in clock control tables within the main memory (step 480). The clock control tables are used to control storage of data in the foreground frame buffer in preparation for display (reference 465).

The clip control data is stored in clip control tables within the main memory (step 485). The clip control data includes data concerning. one or more animations that may be added to a received video signal as part of a customization process. The clip control data for an animation includes data for rendering the animation as well as data for controlling the display of the rendered animation. For example, a rendered animation may be displayed at various locations on a display screen, and thus the data for controlling the display of the rendered animation may specify a location on the screen where the animation is to be displayed. The clip(s) generated according to the clip control tables are passed to the foreground frame buffer in preparation for display (reference 465).

The DSP combines the data in the background frame buffer and foreground frame buffer with the video generated by the image co-processor (step 490). The combined signal is the customized video signal in the form of digital YUV component video (element 315 of FIG. 4). Accordingly, the combined signal is sent to video encoder 320 for conversion into composite video format.

The audio control data is passed to audio control tables within the main memory (step 495). The audio control tables are then used to control the production of audio according to an audio WAV file (step 500). The WAV file audio is generated by audio output hardware 505 such as the audio processing portion 335 of FIG. 4. The WAV file audio may be substituted for a received audio or mixed with a received audio signal. The various ways in which WAV file audio may be used are readily appreciated in view of the discussion of the audio processing portion of FIG. 4.

It should be noted that the invention is not limited to using one WAV file. The invention may make use of more than one WAV file, or no WAV file.

Preferably, the .ctv file is configured such that the .ctv file elements are physically grouped into three primary categories, YUV data, control information and rendered font data. Thus, in a preferred embodiment the .ctv file is partitioned into three parts, a first part made up of the YUV data discussed in connection with step 455, a second part made up of the rendered font data discussed in connection with step 460, and a third part made up of all other file elements discussed in connection with FIG. 6.

As these and other variations and combinations of the features discussed above can be utilized without departing from the present invention as defined by the claims, the foregoing description of the preferred embodiments should be taken by way of illustration rather than by way of limitation of the invention as defined by the claims.

1. An apparatus for customizing a pre-existing signal that includes at least a video signal, comprising:
a video interface for receiving the video signal;
a data interface for receiving data used for customizing the received video signal; and
a processor for generating a customized video signal by applying the received data to the received video signal;
whereby the received data includes at least background data, rendered font data and control data.

2. The apparatus as set forth in claim 1, wherein the video interface comprises an analog decoder.

3. The apparatus as set forth in claim 1, wherein the data interface comprises a port for coupling the unit to a removable solid-state memory.

4. The apparatus as set forth in claim 1, wherein the data interface comprises a port for coupling the unit to a computer.

5. The apparatus as set forth in claim 1, further comprising an analog encoder for receiving the customized video signal and encoding the customized video signal prior to output.

6. A system for customizing a pre-existing audio-visual signal that includes at least a video signal and an audio signal, comprising:
an audio interface for receiving the audio signal of the audio-visual signal;
a video interface for receiving the video signal of the audio-visual signal;
a data interface for receiving data used for customizing the received audio signal and received video signal; and
a processor for generating a customized audio signal by applying a portion of the received data to the received audio signal and a customized video signal by applying a portion of the received data to the received video signal;
whereby the data includes at video customization data, video customization control information, and audio customization control information.

7. The apparatus as set forth in claim 6, wherein the video interface comprises an analog decoder.

8. The apparatus as set forth in claim 6, wherein the audio interface comprises an audio decoder.

9. The apparatus as set forth in claim 6, wherein the data interface comprises a port for coupling the unit to a removable solid-state memory.

10. The apparatus as set forth in claim 6, wherein the data interface comprises a port for coupling the unit to a computer.

11. The apparatus as set forth in claim 6, further comprising an analog encoder for receiving the customized video signal and encoding the customized video signal prior to output.

12. The apparatus as set forth in claim 6, further comprising an audio encoder for receiving the customized audio signal and encoding the customized audio signal prior to output.

13. An apparatus for customizing a pre-existing signal that includes at least a video signal, comprising:
a video interface for receiving the video signal;
a data interface for receiving data used for customizing the received video signal; and
a processor for generating a customized video signal by applying the received data to the received video signal;
whereby the received data includes at least video control data, YUV data, rendered font data, crawl control data, AD and EF control data, clock control data, clip control data, and audio control data.

14. The apparatus as set forth in claim 13, wherein the data is received in the form of a file partitioned into at least three parts, a first part including the YUV data, a second part including the rendered font data, and a third part including the data other than the YUV data and rendered font data.

15. A method for customizing a pre-existing signal that includes at least a video signal, comprising the steps of:
receiving the video signal at a video signal interface;
receiving customization data and customization control information at a data interface; and
generating a customized video signal by applying the received customization data and customization control information to the received video signal.

16. The method as set forth in claim 15, wherein the video signal is received at an analog decoder.

17. The method as set forth in claim 15, wherein the customization data and customization control information is received through a port that couples to a removable solid-state memory.

18. The method as set forth in claim 15, wherein the customization data and customization control information is received through a port that couples to a computer.

19. The method as set forth in claim 15, wherein the step of generating comprises adding text to the received video signal.

20. The method as set forth in claim 15, wherein the step of generating comprises squeezing the received video signal into a portion of a display screen.
